(19) United States
(12) Patent Application Publication
(10) Pub. No.: US 2011/0121609 A1
(43) Pub. Date: May 26, 2011

(54) Vehicle Cab Frame

(76) Inventors: JÖERG JENS HÖEFLE, SEEHEIM-JUGENHEIM (DE); JÜRGEN KASPER, LUDWIGSHAFEN (DE)

(21) Appl. No.: 12/783,688

(22) Filed: May 20, 2010

(30) Foreign Application Priority Data
Jun. 30, 2009 (DE) 10 2009 027 334.4

(51) Int. Cl. B62D 33/06

(52) U.S. Cl. 296/190.08

(57) ABSTRACT

A vehicle cab frame includes a base frame, with connection elements mounted on the base frame, as well as support elements mounted on the connection elements. Functional surfaces for linking attachment parts are formed on the support elements and the functional surfaces have a specified spatial orientation subject to tolerances. In order to improve the positioning accuracy of functional surfaces, the support elements are oriented and positioned relative to the connection elements so that tolerance deviations due to the construction of the base frame can be compensated by corresponding orientation and positioning of the support elements relative to the connection elements.

### FIELD OF THE INVENTION

The present invention relates to a vehicle cab frame.

### BACKGROUND OF THE INVENTION

It is known to provide many types of vehicles with cabs which include a cab frame. For example, construction vehicles or agricultural vehicles have cab frames with a support structure or a support frame constructed as a welded construction using steel-pipes. Such welded constructions pose the problem that the support frame is exposed to uncontrollable deformation or uncontrollable warping due to the introduction of heat because of heating during the welding process and also because of cooling afterwards, so that dimensional tolerances are often difficult to observe or cannot be observed, and finishing work of the already welded support frame is required so that the vehicle cabin attachment parts that are mounted on the support frame with a certain sensitivity to tolerances specific to the processing can be mounted with dimensional precision. Such attachment parts can represent inner and outer lining elements, doors, winds, seals, etc. For example, due to the warping of the support frame, problems can occur with respect to handling that is reliable during processing for the tolerance-sensitive functions to be performed by the support frame, such as, e.g., the provision of an exact positioning of the attachment point for a door hinge, a dimensionally precise adhesive surface geometry for the bonding of glazing, a dimensionally precise sealing surface for doors and plates or an exact positioning of the attachment point for a roof structure or for a cabin lining.

### SUMMARY

Accordingly, an object of this invention is to provide a vehicle frame to which vehicle cabin attachment parts can be mounted with dimensional precision.

This and other objects are achieved by the present invention, wherein a vehicle cab frame is constructed so that the support elements can be oriented and positioned relative to the connection elements mounted on the base frame such that tolerance deviations due to a construction method (for example, welding) of the base frame can be compensated by the corresponding orientation and positioning of the support elements relative to the connection elements. The connection elements and the support elements are positioned on the base frame independent from the actual welding production of the base frame, so that the frame warping generated during the welding of the base frame can be optimally compensated by the positioning of the support elements. Here, the connection elements can be welded on the base frame at provided or specified positions, advantageously simultaneously, together with the support elements or can be mounted on this base frame in some other way. In this way, the support elements can be oriented exactly with respect to a specified spatial geometry (edge geometry or orientation of the functional surfaces of the support elements in a specified spatial geometry) and can be mounted with positional precision on the previously welded base frame. The production sequence named above can also be performed not simultaneously but instead sequentially as a function of the specified spatial geometry or component geometry.

The base frame can comprise several posts, advantageously steel posts, welded with each other, wherein the base frame represents a solid base construction through which both static and also dynamic, safety-relevant forces on the vehicle can be absorbed. Thus, for example, the post thickness is dimensioned such that, if the vehicle rolls over, several times the weight of the vehicle can be absorbed by the base frame construction.

The base frame could comprise posts, advantageously steel posts, formed as tubular posts. Tubular posts can have advantages in shaping in a bending process and/or in joining in a welding process (or a different joining process, for example, bonding) compared with other, for example, rectangular post shapes, because tubular posts are not sensitive to twisting due to their uniform outer surface, so that during the bending process and/or also during the joining of the posts, essentially no attention must be given to the orientation of the outer surface. A cylindrical outer surface of a tubular post, however, can have disadvantages compared with a flat outer side of a rectangular post for a tolerance-precise orientation, positioning, and/or attachment of components, if the outer surface is used directly as a reference and connection surface, which is why conventionally the use of tubular posts for constructions with tolerance-precise component positioning and component connections had been avoided. For a frame construction according to the invention, such aspects can be disregarded, so that for the construction of the base frame, both tubular posts, cylindrical or circular and also rectangular cross sections, could be used, because here the tolerance-precise orientation, positioning, and/or attachment of components is performed exclusively in combination of the connection elements with the support elements and one is not bound in the typical way to the form of the outer surface of the post. Also, the use of posts with mixed cross sections is not a problem, so that, in one construction, posts of different forms and different cross sections can be combined with each other easily. It should be noted that posts of other cross sections can also be used in the same way, for example, L-posts, I-posts, T-posts, U-posts, or also oval-shaped posts.

The base frame can be formed, for example, as a base frame of a vehicle cabin, with the support elements being arranged on an outer side of the base frame. As already mentioned, a large part of the forces acting on the frame construction are absorbed by the base frame. The support elements and the connection elements take up only a very small portion, essentially only the dead weight of the outer parts mounted on them in the vehicle cabin, such as car body parts, linings, doors, panels, etc. Such a frame construction, however, is not limited to just use for vehicle cabins.

The base frame comprises, with respect to the orientation of the vehicle cabin, front and/or rear posts extending vertically on which the support elements are mounted. In addition to a closed construction with a vehicle cabin roof, two front posts, and two rear posts, an open construction or a partially open construction of the vehicle cabin is also possible, so that the vehicle cabin has a cantilevered roof that is supported by only the rear or front posts. The use of a frame construction according to the invention as a so-called roll-over protection system (ROPS) is also conceivable.

The support elements have functional surfaces that can be formed as adhesive surfaces, sealing surfaces, positioning surfaces, or door-hinge-link surfaces and are thus subject to a high positioning tolerance. Deviations that lie outside of the specified tolerance range can lead to leaks or functional interference in the activation of doors or windows. Furthermore, functional interference can also occur in adhesive surfaces, so that, for example, an adhesive connection is realized defectively. The same applies for sealing surfaces that do not satisfy a specified tolerance dimension. In addition, assembly problems can occur in series production.

The support elements and/or the connection elements could be constructed as shaped sheet steel, wherein the material thickness of the support elements is smaller than that of the steel posts of the base frame.

Therefore, because a smaller material thickness is to be processed, in particular, is to be connected to each other, lower quantities of thermal energy can be applied in a welding process, in order to weld the parts to each other. Therefore, the distortion generated during the welding is also reduced during the heating and cooling of the parts welded to each other. This results in higher dimensional accuracy and therefore also higher tolerance accuracy. Thus, frame distortion generated during the welded construction of the base frame can be compensated by the attachment of the connection and support elements or by their exact positioning, without additional, excessive distortion of the connection and support elements welded to each other leading to tolerance errors.

The support elements are provided with openings or recesses through which the connection elements extend at least partially. The position of the support elements or the openings of the support elements can thus vary with respect to the connection elements. Thus, the support elements are advantageously oriented together with the connection elements if needed according to the specified spatial geometry, wherein the openings of the support elements are constructed such that a maximum tolerance deviation to be expected in the base frame can be compensated through corresponding positioning of the openings relative to the connection elements and are welded or connected to the connection elements in an additional step. The connection elements are used here as spacers between the base frame and support element. According to the frame distortion on the base frame, individual regions on the support element can be positioned differently close to or far from the corresponding base frame post, so that distance differences between the support frame and base frame can be set at several positions along a base frame post, wherein a tolerance compensation or a spacing correction is possible with respect to several degrees of freedom.

The connection elements can be welded or also, for example, bonded on the base frame, wherein other attachment forms are also conceivable. In the same or similar way, the support elements could also be welded to the connection elements or bonded with these elements.

The support elements arranged on a post can be constructed in one piece, so that they extend across the entire length of the post. Here, several connection elements are arranged distributed across the length of the posts that correspond, on the support elements, with openings distributed across the length of the support elements. It is also possible, however, to construct the support elements on a post in several parts.

### BRIEF DESCRIPTION OF THE DRAWINGS

FIG. 1 is a schematic side view of an agricultural vehicle;

FIG. 2 is a schematic perspective view of a frame construction according to the invention for a vehicle cabin of a vehicle of FIG. 1;

FIG. 3 is a schematic perspective rear view of the frame construction of FIG. 2 on a rear post;

FIG. 4 is a schematic perspective side view of the frame construction of FIG. 2 on the rear post of FIG. 3;

FIG. 5 is a schematic top view of the frame construction of FIG. 2 on the rear post of FIGS. 3 and 4;

FIG. 6 is a perspective side view of the frame construction of FIG. 2 on a front post; and

FIG. 7 is a schematic top view of the frame construction of FIG. 2 on the front post of FIG. 6.

### DESCRIPTION OF THE PREFERRED EMBODIMENT

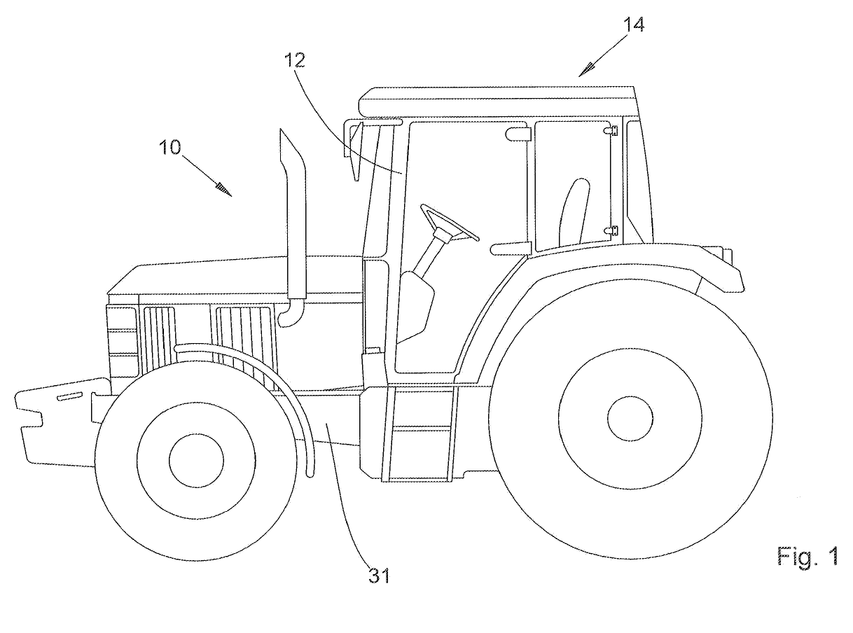

Referring to FIG. 1, an agricultural vehicle 10, such as for example, a tractor or hauler, has a cabin 12 that is constructed as a frame 14. The vehicle 10 could also be some other agricultural vehicles (e.g., harvesting machines, spraying machines, loaders, etc.) or a vehicle in the construction sector (e.g., wheel loaders, backhoes, diggers, etc.) or forestry equipment (e.g., pull-back machines).

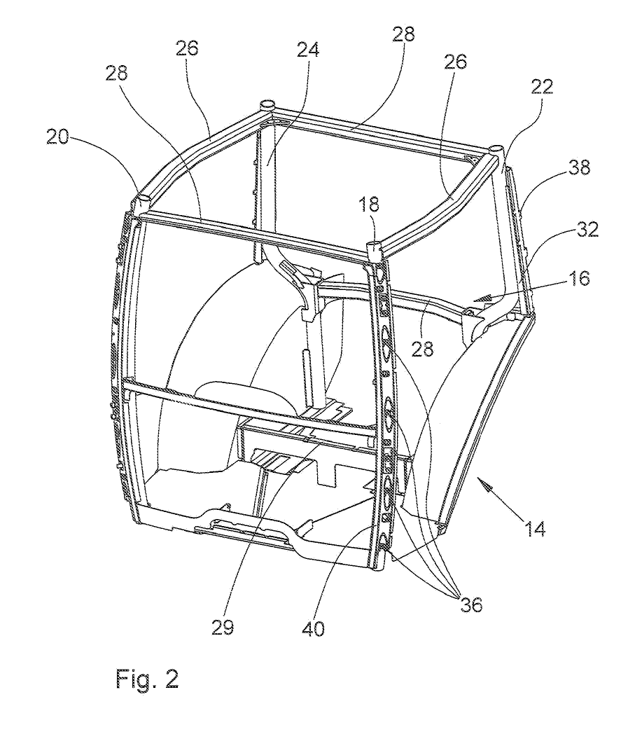

The frame 14 includes a base frame 16 that is welded together (see, in particular, FIG. 2). The base frame includes two front posts 18, 20, advantageously steel, extending essentially vertically, as well as two rear posts 22, 24, advantageously steel, extending essentially vertically, wherein the posts 18, 20, 22, 24 were subjected to specified shaping in a preceding bending process.

The posts 18, 20, 22, 24 are welded with posts 26 running longitudinal to the direction of travel of the vehicle 10 and with post 28, advantageously steel posts, running perpendicular to the direction of travel of the vehicle 10, which were likewise subjected to shaping by bending. Alternatively, the posts 18, 20, 22, 24, 26, 28 could also be bonded to each other. The thickness and dimensions of the posts 18, 20, 22, 24, 26, 28 are such that they can withstand loading that is caused by an accident and that can correspond to several times the weight of the vehicle. For example, if the vehicle rolls over, to a large extent it is guaranteed that the posts do not buckle. By means of an additional post 29 running perpendicular to the direction of travel of the vehicle 10 on a lower region of the frame 14 and a base plate 30, the frame 14 is connected to a frame 31 of the vehicle 10. With respect to a typical designation in vehicle construction for frame structures of car bodies and cabins, the posts 18, 20 are comparable to an A-pillar (front post) and the posts 22, 24 are comparable to a C-pillar (rear post), wherein, in the present example, the frame 14 has no middle B-pillars in this respect.

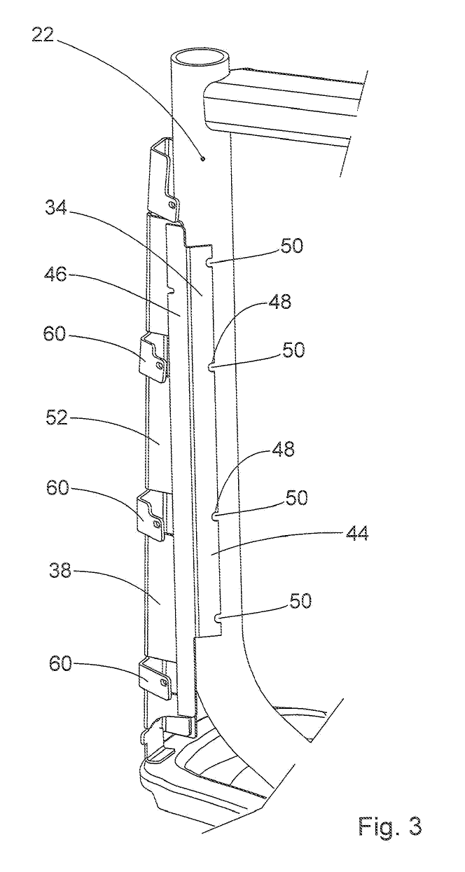

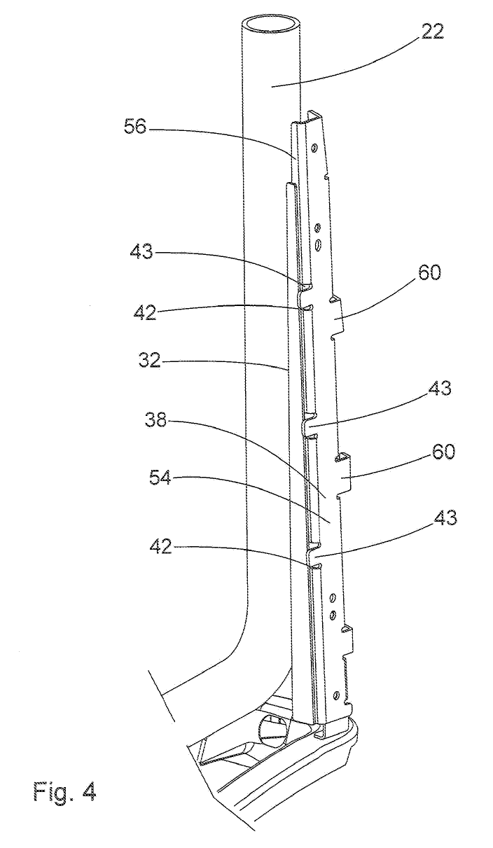

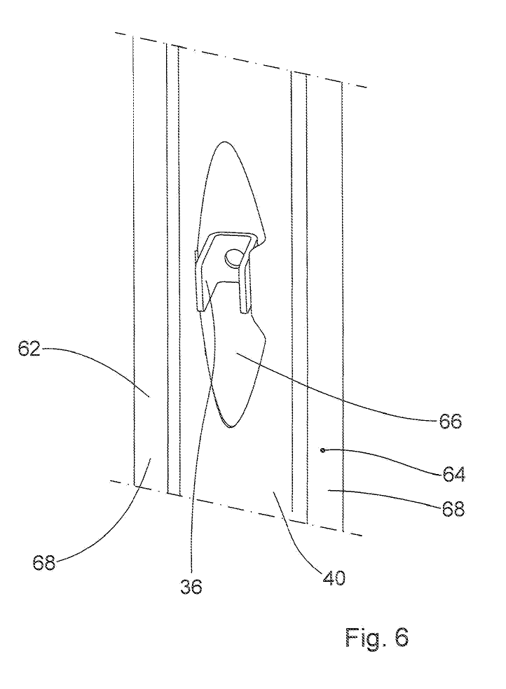

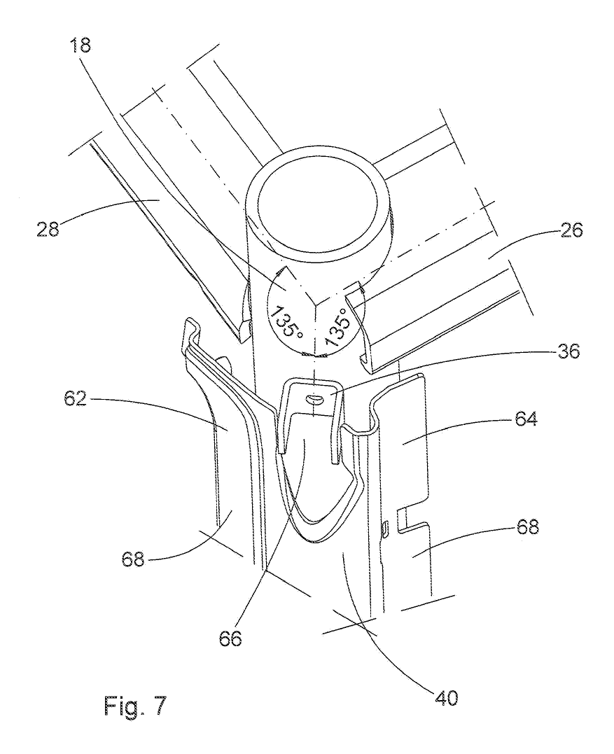

The frame 14 further comprises connection elements 32, 34, 36, wherein the connection elements 32, 34 are arranged on the rear posts 22, 24 and the connection elements 36 are arranged on the front posts 18, 20. The arrangement and construction of the connection elements 32, 34 are especially clear with reference to FIGS. 3-5 (as well as FIG. 2) and the arrangement and construction of the connection elements 36 are to be seen with reference to FIGS. 6 and 7 (as well as FIG. 2), wherein the posts 22 arranged at the back left in the direction of travel in the example in FIGS. 3-5 and the posts arranged at the front left in the direction of travel in the example in FIGS. 6 and 7 are shown with respect to the frame 14.

The frame 14 further comprises support elements 38, 40, wherein support elements 38 are arranged on the rear posts 22, 24 and the support elements 40 are arranged on the front posts 18, 20. The arrangement and construction of the support elements 38 is clear with reference to FIGS. 3-5 (as well as FIG. 2) accordingly and the arrangement and construction of the support elements 40 are to be seen with reference to FIGS. 6 and 7 (as well as FIG. 2).

Thus, the frame 14 comprises two embodiments that differ from each other for the arrangement and construction of the connection elements 32, 34, 36 and the support elements 38, 40 that are described in detail below.

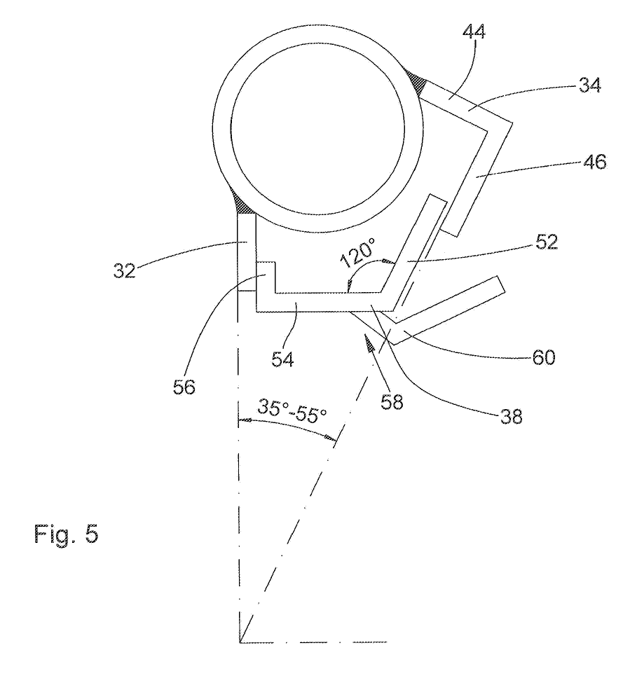

The connection element 32 is in the form of a flat steel bar or a flat steel sheet or a steel band (see cross section in FIG. 5) and extends in the direction of its length along the length of an upper, outer region of the post 22. The connection element 32 is oriented in the direction of its width essentially perpendicular to the direction of travel of the vehicle 10, wherein the connection element 32 is welded or bonded along its longitudinal edge with the surface of the post 22 directed outward and lateral to the vehicle 10 with respect to the frame 14. Optionally, notches or recesses 42 that are used as positioning aids for the elements 32, 38 relative to each other are provided on the longitudinal sides of the support element 38 and also the connection element 32, in that these aids can be brought into engagement with each other.

The other connection element 34 arranged on the rear post 22 is in the form of a steel sheet formed as an L-post in its width cross section with two legs 44, 46 arranged at approximately 90° to each other (see cross section in FIG. 5, wherein the angular dimensions are set to 90° only as an example and obviously could also be larger or smaller) and extend in the direction of its length along the length of the same upper and outer region of the post 22, wherein one of the legs 44 is welded or bonded along its longitudinal edge with the surface of the post 22 directed outward and at the rear to the vehicle 10 with respect to the frame 14 such that the other leg 46 is oriented approximately at an angle of 35°-55° to the orientation of the connection element 32 (see cross-sectional drawing with angular details in FIG. 5, wherein the angular dimensions are set to 35°-55° only as an example and obviously could be larger or smaller). Optional notches or recesses 48 that are used as positioning aids could be provided on the longitudinal edge of the connection element 34 or the leg 44 welded or bonded with the post 22, in that they can be brought into engagement with raised sections 50 that could be formed accordingly on the rear outer surface of the post 22.

As can be seen in FIG. 5, the support element 38 is formed as a steel post extending along the connection elements 32, 34 and has two legs 52, 54 that extend in the width direction and that are dimensioned with an opening angle of approximately 120° relative to each other (see cross-sectional view in FIG. 5, wherein the angular dimensions are set to 120° only as an example and obviously could also be larger or smaller). The longitudinal edge of the leg 54 is provided with flanging 56 at approximately 90° relative to the leg axis of the leg 54.

As is to be seen especially well in FIG. 5, the connection element 32 and the leg 46 of the connection element 34 form a positioning opening 58 that extends in the longitudinal direction of the upper, outer region of the post 22 and by means of which the support element 38 can be positioned and can be connected, advantageously welded or bonded, at the leg 52 with the leg 46 of the connection element 34 or at the leg 54 with the connection element 32.

Several functional surfaces 60 that are distributed across the length and on which, for example, a cabin door (not shown) or lining elements can be attached are formed on the support element 38.

The positioning opening 58 between the connection elements 32 and 34 is dimensioned such that the support element 38 can be oriented within the positioning opening 58, so that existing warping of the base frame 16 or the total deviations relative to specified spatial geometry dimensions for the functional surfaces 60 that are formed on the support element 38 and that are formed as door-hinge links in the embodiment shown in FIGS. 3-5 can be compensated by corresponding positioning of the support element 38. The material thickness values of the connection elements 32, 34 and the support element 38 are clearly smaller than the wall thickness of the posts of the base frame 16, so that when the support element 38 is welded with the connection elements 32, 34, a smaller introduction of heat is required, wherein thermal warping of the connection elements 32, 34 and the support element 38 can be essentially avoided or can move within the permitted tolerances, so that, overall, the required spatial geometry dimensions for the functional surfaces 60 can be observed or achieved easily and precisely through corresponding positioning of the support element 38. Alternatively, the connection elements 32, 34 could also be bonded to the support element 38, so that otherwise no thermal warping occurs.

An additional arrangement and orientation of connection elements 32, 34 and the support element 38 are found in a corresponding manner on the other rear post 24.

The connection elements 36 of the second embodiment shown in FIGS. 6 and 7 are U-posts that are made from sheet steel and that are arranged on an outer region of the posts 18, 20 spaced apart from each other along the length of the posts 18, 20 and welded or bonded with the posts. The connection elements 36 are arranged such that the legs of the u-shaped connection elements 36 are directed outward and oppose each other in the horizontal direction, wherein the orientation is selected such that the legs extend approximately along the bisecting ling of an angle between the front and side surfaces of the vehicle cabin 12, that is, approximately enclosing an angle of 135° with the front or side or side surface (see angular details in FIG. 7, wherein the angular dimensions are set to 135° only as an example and obviously could also be larger or smaller).

As is to be seen in FIGS. 6 and 7, the support element 40 is constructed as a steel post extending in its length along the post 18 and has two legs 62, 64 that extend in the width direction and that stand at an opening angle of approximately 90° relative to each other. (See FIG. 7, wherein the angular dimensions are set at 90° only as an example and obviously could also be larger or smaller). The longitudinal edge of the leg 62 is provided with flanging at approximately 90° relative to the leg axis of the leg 62.

Along the length of the support element 40 there are oval-shaped positioning openings 66 between the legs 62, 64, that is, in the corner region of the support element 40 or in the region in which the legs 62, 64 contact each other, wherein these openings correspond in number and arrangement to those of the connection elements 36. The positioning openings 66 have a width diameter that corresponds approximately to the outer distance of the two legs of the connection elements 36, so that the legs of the connection elements 36 can extend through the positioning openings 66.

The support element 40 is positioned such that the legs of the connection elements 36 are brought into engagement with the positioning openings 66, wherein according to the orientation of the support element 40, the legs can project at different lengths through the positioning opening. According to a tolerance-precise orientation and arrangement of the support element 40 at the edge of the positioning openings 66, the legs of the connection elements 36 are connected, advantageously welded or bonded to the support element 40.

On the support element 40, there are functional surfaces 68 extending along the legs 62, 64 in the longitudinal direction of the support element 40 in the form of an adhesive surface and/or sealing surface on which glazing (not shown) can be bonded for the vehicle cabin 12 or that can be used as the sealing surface for a door seal of a cabin door (not shown).

The positioning openings 66 as well as the form and length of the legs of the connection elements 36 are dimensioned such that the support element 40, first, can be oriented and, second, it is guaranteed that after orienting the support element 40, the legs of the connection elements 36 can still be connected to the edge of the positioning openings 66. The orientation is realized such that existing warping of the base frame 16 or total deviations relative to specified spatial geometry dimensions for the functional surfaces 66 that are formed on the support element 40 and that are constructed as adhesive and/or sealing surfaces in the embodiment shown in FIGS. 6 and 7 can be compensated by the corresponding positioning of the support element 40. The material thickness values of the connection elements 36 and the support element 40 are here significantly smaller than the wall thickness values of the posts of the base frame 16, so that, when the support element 40 is welded with the connection elements 36, a smaller introduction of heat is required, wherein thermal warping of the connection parts 36 and the support element 40 can be avoided or can move within permitted tolerances, so that overall the required spatial geometry measures for the functional surfaces 66 can be maintained or achieved easily and precisely through corresponding positioning of the support element 40. Alternatively, the connection elements 36 can also be bonded with the support element 40, so that no thermal warping otherwise occurs.

An additional arrangement and orientation of connection elements 36 and the support element 40 are found in a corresponding manner on the other front post 20.

Even if the invention was described merely with reference to two embodiments, in the light of the preceding description as well as the drawings, many different types of alternatives, modifications, and variants that fall under the present invention present themselves for someone skilled in the art. For example, the connection elements 32, 34, 36 or also the support elements 38, 40 could be shaped differently and could be connected to each other in different ways. The positioning openings 58, 66 and connection points can be supported at different positions. Furthermore, the support elements 38, 40, as well as the connection elements 32, 34, could also be formed in multiple parts, which is different than as shown in the example here. The posts 18, 20, 22, 24 (A-pillar and C-pillar) formed as cylindrical tubular posts in the frame 14 could also be formed as differently shaped tubular posts or even as open posts (e.g., as I-posts, T-posts, L-posts, U-posts, etc.).

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A vehicle cab frame with a base frame, connection elements mounted on the base frame, as well as support elements mounted on the connection elements, wherein functional surfaces for linking attachment parts are formed on the support elements and the functional surfaces have a specified spatial orientation subject to tolerances, characterized by:
the support elements being oriented and positioned relative to the connection elements so that tolerance deviations caused by construction of the base frame can be compensated through corresponding orientation and positioning of the support elements relative to the connection elements.

2. The cab frame of claim 1, wherein:
the base frame comprises several posts that are welded or bonded to each other.

3. The cab frame of claim 1, wherein:
the base frame comprises several posts formed as tubular posts.

4. The cab frame of claim 1, wherein:
the support elements are arranged on an outer side of the base frame.

5. The cab frame of claim 4, wherein:
the base frame comprises front and rear vertically extending posts on which the support elements are mounted.

6. The cab frame of claim 1, wherein:
the support elements have functional surfaces including at least one of an adhesive surface, a seal surface, a positioning surface, and a hinge link surface.

7. The cab frame of claim 2, wherein:
the support elements are formed from unshaped sheet steel, and the support elements have a material thickness which is smaller than that of the posts of the base frame.

8. The cab frame of claim 2, wherein:
the connection elements are formed from unshaped sheet steel, and the connection elements have a material thickness which is smaller than that of the steel posts of the base frame.

9. The cab frame of claim 1, wherein:
the support elements are provided with openings or recesses through which the connection elements extend at least partially.

10. The cab frame of claim 1, wherein:
the connection elements are welded or bonded to the base frame.

11. The cab frame of claim 1, wherein:
the support elements are welded or bonded to the connection elements.

12. The cab frame of claim 1, wherein:
the support elements are arranged on a post and have a one-piece construction.
